(19) United States
(12) Patent Application Publication
(10) Pub. No.: US 2008/0088413 A1
(43) Pub. Date: Apr. 17, 2008

(54) System and Components Thereof for Carrying Out Signal Processing Operations Including a Synthetic Aura Suitable for Presence Detection

(75) Inventor: Wolfgang Richter, Germering (DE)

Correspondence Address: KATTEN MUCHIN ROSENMAN LLP, 575 MADISON AVENUE, NEW YORK, NY, 10022-2585, US

(73) Assignee: IDENT TECHNOLOGY AG, Wessling (DE)

(21) Appl. No.: 11/720,003

(22) PCT Filed: Nov. 23, 2005
(86) PCT No.: PCT/EP05/12544

§ 371 Date: Nov. 28, 2007

(30) Foreign Application Priority Data
Nov. 23, 2004 (DE) 10 2004 056 533.3
Nov. 23, 2004 (DE) 10 2004 059 669.7

(51) Int. Cl. B60R 25/00; G07C 9/00

(52) U.S. Cl. 340/5.72

(57) ABSTRACT

The invention relates to a system and to the components thereof for carrying out signal processing operations including a synthetic aura which is suitable for presence detection and which the invention is to provide solutions enabling improvements in handling and user security to be obtained synergetically while producing comfort-increasing keyless access circuit systems. This aim is achieved, according to a first aspect of the invention, by means of a system for carrying out signal processing operations, taking into signals which are indicative of an area intrusion. Said system comprises means for generating the signals which are indicative of an area intrusion, based on electrical field interaction effects and circuit provisions, for automatic initiation of operations according to signals which are indicative of an area intrusion.

The invention relates to a system and components thereof for executing signal-processing sequences with inclusion of a synthetic aura that is suitable for presence detection and that if necessary is user-specific. Furthermore, the invention also relates to signal-processing methods based on indicative signals obtained with respect to a user presence.

The object of the invention is to provide solutions in which handling and user-safety gains can also be achieved synergetically in connection with the implementation of comfort-increasing circuit systems, especially “keyless access” circuits.

According to a first aspect of the invention, this object is achieved by a system for executing signal-processing sequences by taking into consideration signals indicative of zone intrusions, wherein this system includes means for generation of the signals indicative of zone intrusions on the basis of electric-field interaction effects, and circuitry is provided for automatic sequence initiation on the basis of the signals indicative of zone intrusions.

In this context the inventive solution permits in particular
protection of equipment/vehicles from unauthorized use, for example by unauthorized persons
increased safety of persons in phases relevant to danger; for example, the lighting situation can be improved if certain vehicle lighting devices are turned on automatically in response to being approached
reduction of the danger of injury in the region of pinching points at closing edges of windows, doors, trunk lids and engine hoods
protection against loss (losing during entry)
protection against faulty trips (correct manipulation, clear intent to open, codable triggering)
control of sequences as a function of detected danger zones (warning, slowing, stopping)

On the basis of the inventive solution, it is possible by circuitry to create “keyless” access systems that can be advantageously implemented. These access systems can be implemented such that they are characterized by small power consumption and low system costs. The inventive concept makes it possible to obtain lead time in (data) processing and in this way permits the use of relatively slow mechatronic components.

In conventional keyless access systems, the signal transfer used for verification of authorization is usually radio-based.

Results Achievable on the Basis of the Invention

Existing radio key systems are made more comfortable by the invention:
contactless
fewer handling operations of the user; in addition, safety close to the door is increased by:
detection of unauthorized persons
prevention of danger situations (pinching)
recognition of correct handling prerequisites (starter knob can be actuated only from driver's seat)
only one single sensor with a plurality of selectable electrodes
definable proximity/contact-sensitive zones
shield relative to ground
signal output via electrode surface (multiple function: either sensor, ground or emitter)

Proximity-Sensitive Means
approach from outside to a handle/operating knob, etc.
preparatory measure (such as waking up control unit) for slower and therefore less expensive mechatronics;
position detection (distance (range), inner/outer enclosure)

Triggering Means
bypassing one or more button functions in remote controllers being worn or carried (radio key)
codable (data modulation)
power-saving sleep condition

System Description:

Components:
identity approach sensor, for example according to German Patent Application 10305342.5-52 of the Applicant
inventive circuit arrangement for electrode-control of body-emitter unit (BEU) and body-detector unit (BDU)

A particular synergetic effect is achieved by the inventive concept when the presence-detection technique is simultaneously used for data transfer. By means of the data transferred while a presence condition exists, switching sequences can be initiated on the part of the detected object. These switching sequences can be signal-generation sequences, which use other physical effects to achieve signal transmission. Specifically, if the presence of the limbs of a user in a handle zone of a vehicle meets sufficient or other criteria when detected, a radio key worn or carried by the user can be activated via the detection system.

Further details and features of the invention will become apparent from the description hereinafter in conjunction with the drawing, wherein:

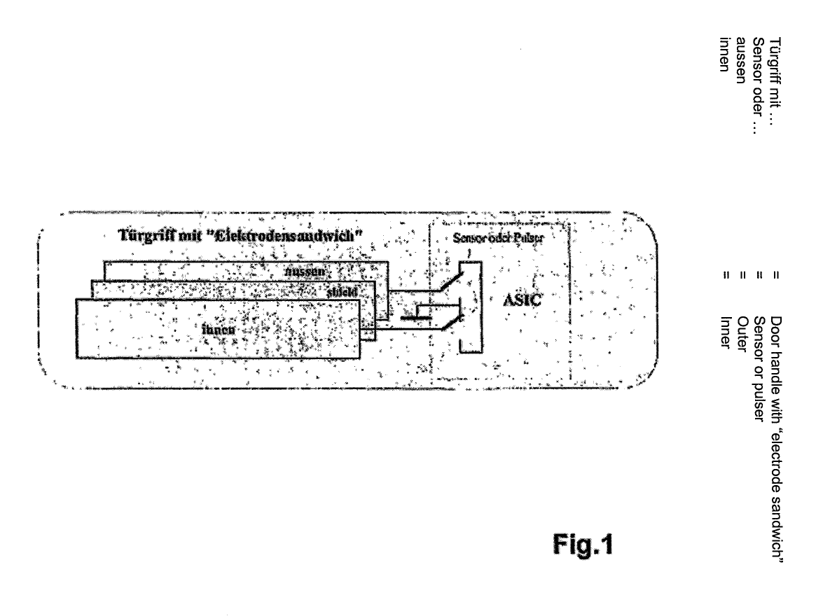

FIG. 1 shows a schematic diagram for explanation of the structure of a door handle with a plurality of electrode devices for detecting the penetration, into the zone surrounding the handle, of signals that are indicative of intrusions and that also permit verification of authorization;

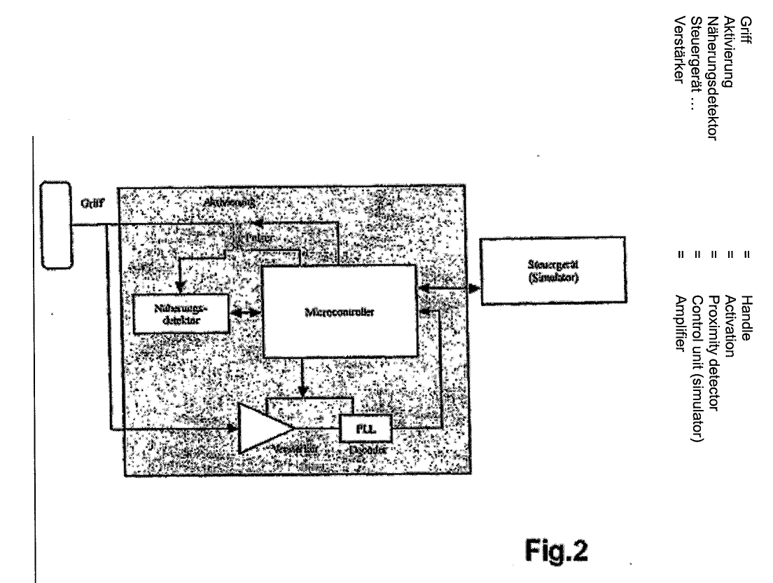

FIG. 2 shows a block diagram for explanation of the structure of a variant, provided on the handle side, of an emitter unit provided to output signal sequences;

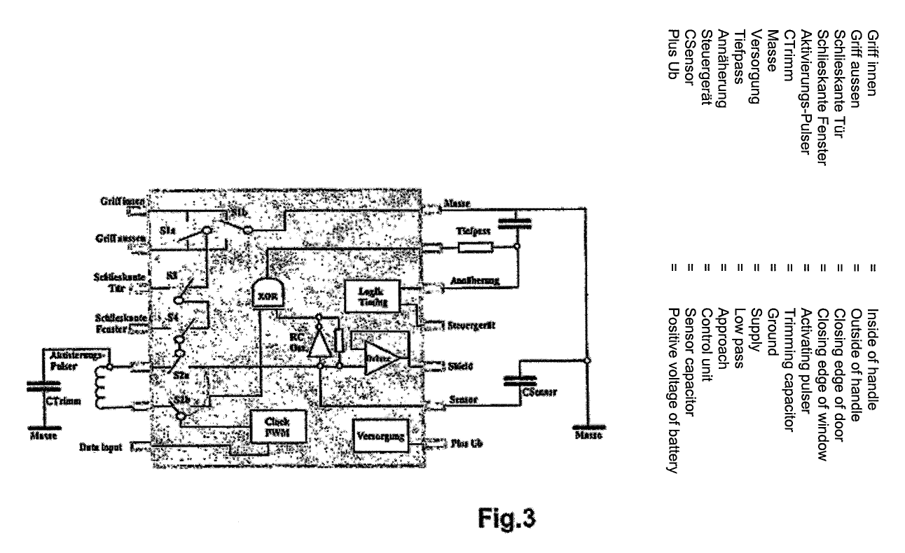

FIG. 3 shows a further block diagram for explanation of a preferred structure of the emitter unit;

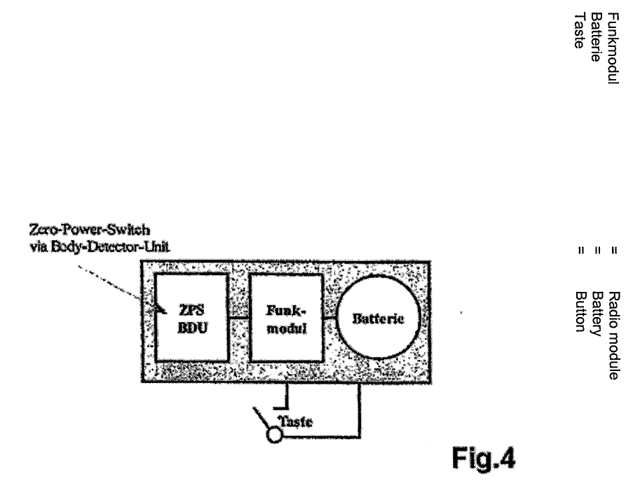

FIG. 4 shows a block diagram for explanation of the structure of a detector unit, provided on the key side, for reception of a signal provided for further initiation of key functions;

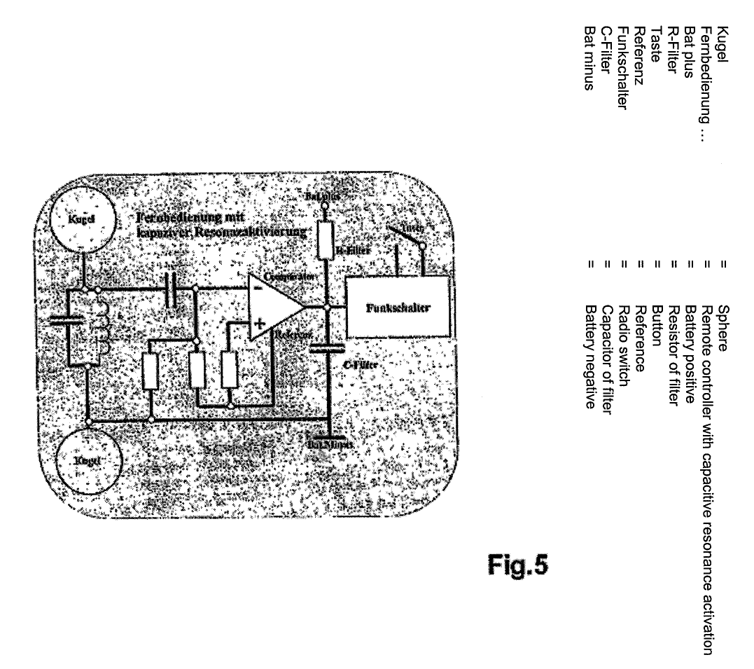

FIG. 5 shows a block diagram for explanation of the structure of an inventive remote controller with capacitive resonance activation;

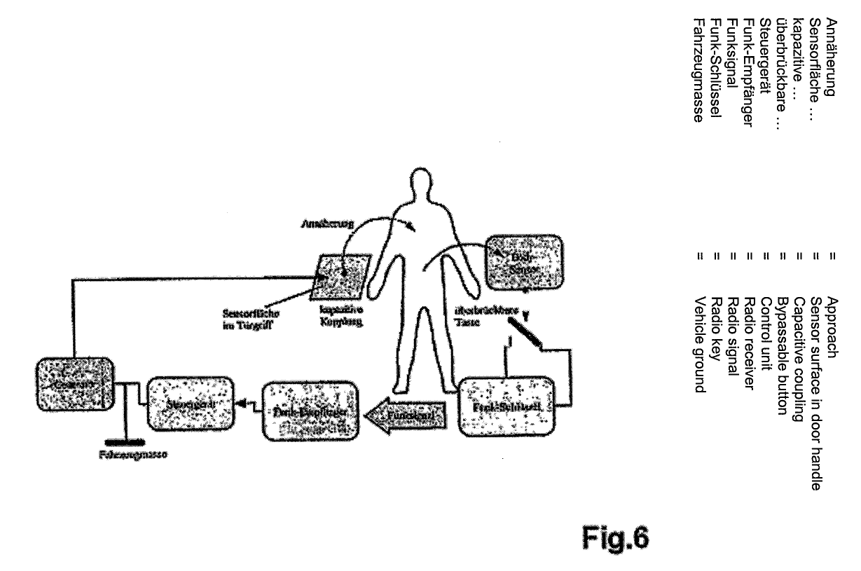

FIG. 6 shows a schematic diagram for illustration of the functional principle of a door-locking system implemented by including the inventive technique;

FIG. 5 shows a further block diagram for explanation of the use of the inventive technique in conjunction with a traditional radio key.

FIG. 1 shows a variant of an inventive circuit arrangement for electronic activation of a vehicle door handle device containing an integrated “sandwich sensor”. Capacitive fields can be detected in particular via isolated and preferably ungrounded electrode systems, which are formed by conductive components in themselves, or by foil surfaces and/or even by wire segments. The sandwich sensor comprises three foils (outer, shield, inner) as well as a changeover device (such as an electrical two-way switch) for changing over between an external and an internal query, wherein one of the foils is connected to the detector while the other foil is connected to ground. The interposed shield foil is activated in phase by the sensor via a shield driver. An additional changeover device permits activation of the body emitter unit. Via the selected foil, this then generates a low-current a.c. signal with high voltage level (80 Vpp and higher), which can be modulated with data (such as ASK, FSK, QPSK). Furthermore, the inventive arrangement permits interfacing of zones relevant to danger or contact (vehicle door) to the detector, which is preferably integrated in an ASIC. Zones relevant to danger are all pinch points, such as the closing edges of the door. Preferably a detecting wire together with a shield can be installed in the sealing materials. Since these are frequently spaced apart from the actual closing edge, the sensitive zone is controlled by special arrangement and construction of the shield in this zone. Contact-sensitive zones can be the starter knob or other functional elements, such as the seat surfaces of the driver and front-seat passenger.

The special circuit arrangement makes it possible to use the said elements either for approach or contact detection and/or for sending out activation signals of the BEU. In this way it is supposedly ensured that, in contrast to known transponder systems, control operations are always the consequence of human actions, such as grasping, pulling, setting down, pushing, etc.

FIG. 2 shows a circuit variant with a body-emitter unit BEU disposed in the vehicle handle. The BEU is the interface between pulse transmitter and the human. Pulses for wake-up, detection and identification are transmitted via it to the skin of the human. The overall unit also includes a proximity sensor, a level shifter, a pulser (high-voltage generator, such as a resonance circuit and/or transformer) and a microcontroller, which contains the identification code and further logic (firmware).

Body-Emitter Unit BEU in the Vehicle:

In addition, it is possible to equip switches and operating elements with separate BEUs, which can also be activated in tactile manner, for example, or in other words during the switching operation. The activation signal is then guided capacitively via the skin of the operator to a BDU and evaluated either there or in a control unit.

FIG. 3 shows an inventive module that can achieve all necessary functions with only a few gate functions. The external components (such as shield and sensor foils or wires) are interfaced via integrated high-side switches.

FIG. 4 shows a schematic diagram of a body-detector unit BDU in the radio key (otherwise known as the remote key). Body detector unit BDU is the interface between the human and the pulse receiver. Pulses for wake-up, detection and identification are transmitted via it to the system in the remote key.

The overall unit also includes a filter, a power-saving operational amplifier connected as a comparator, and a switch (ZPS). The ZPS wakes up the BDU, which in turn activates the radio module in the remote key.

Body-Detector Unit BDU in the Vehicle Also:

Trigger pulses generated by approach to or contact with switches and components in a vehicle are detected, evaluated and converted to switching operations by one or more BDUs. In addition to the BDU in the radio key, these can also be used in other switching elements in the vehicle, in order to initiate switching operations upon contact or body proximity (in the seat). For example, it is possible in this way to determine whether a driver or a front-seat passenger is actuating a given knob.

FIG. 5 illustrates a preferred embodiment of the circuitry of a BDU. In principle, a BDU is composed of a capacitive transducer, a selective amplifier and a data-retrieval device. Numerous variants are possible. In view of the imperative requirement of minimal power consumption and complexity (costs, circuit), the inventive solution uses an arrangement that essentially comprises a power-saving comparator. Its positive input is connected via a resistor to a reference voltage. The negative input is biased sufficiently that the switching threshold is not quite attained. Via a capacitor there is applied a parallel oscillating circuit, which is connected to ground at one end and to an advantageous capacitive pick-up surface at the other end. The oscillating circuit is selected in such a way that it is in resonance with the output frequency of the BEU and conducts through the negative of the comparator. At its output there is disposed an RC element as a filter, so that the input alternating current generates a logical zero during its detection. If the input signal is pulsed according to a well defined pattern, this can be queried at the output of the comparator as a corresponding data signal (ASK). By selection of various capacitors in the input oscillating circuit, there can also be detected various frequencies. In this way other modulation methods (FSK, PSK) can be used. The signals are interfaced with the negative input of the comparator for 2 reasons:

1. to prevent the output signal from being coupled back to the input and thus causing oscillation of the arrangement.

2. the comparator can be turned on and off cyclically for further power savings.

The high signal that is present at the output is clearly different from the turn-off signal. It then indicates readiness for operation and leads to immediate disconnection if no trigger signal has been detected.

Since the input level is decisive for the trigger threshold, approach detection can also be established in simple manner: The trigger signal at the outer output foil of a handle has a constant a.c. voltage level, which on the basis of the capacitive coupling to the hand being extended toward it reaches the switching threshold in the BDU only at a certain distance to the handle. Thus an approach would be detectable even without an explicitly mounted approach sensor, since the activated remote controller then sends out a radio signal confirming the operation. However, unknown persons cannot be detected with this solution. Therefore a passive approach sensor is additionally used in the invention. Through interaction with the BDU, which is turned on beginning at a certain distance, it is then additionally possible to ensure that the switching threshold is attained only upon continued approach to the handle, thus greatly increasing the error tolerance.

The highest level will naturally be transmitted upon contact with the handle, because there the capacitive coupling is the greatest.

In principle, such a circuit is also suitable for installation in lock cylinders of stationary doors. Instead of a radio switch, there can be installed therein a logic unit that unlocks the lock. An operator could then wear or carry a BEU containing an appropriate access code.

As a further feature, the surfaces shown as examples for picking up the capacitively transmitted signals have spherical structure, so that uniform field coupling can always be achieved regardless of where the remote controller is located on the body of the operator. A structured or roughened (and thus enlarged) surface k, in order to improve the capacitive coupling for the same volume.

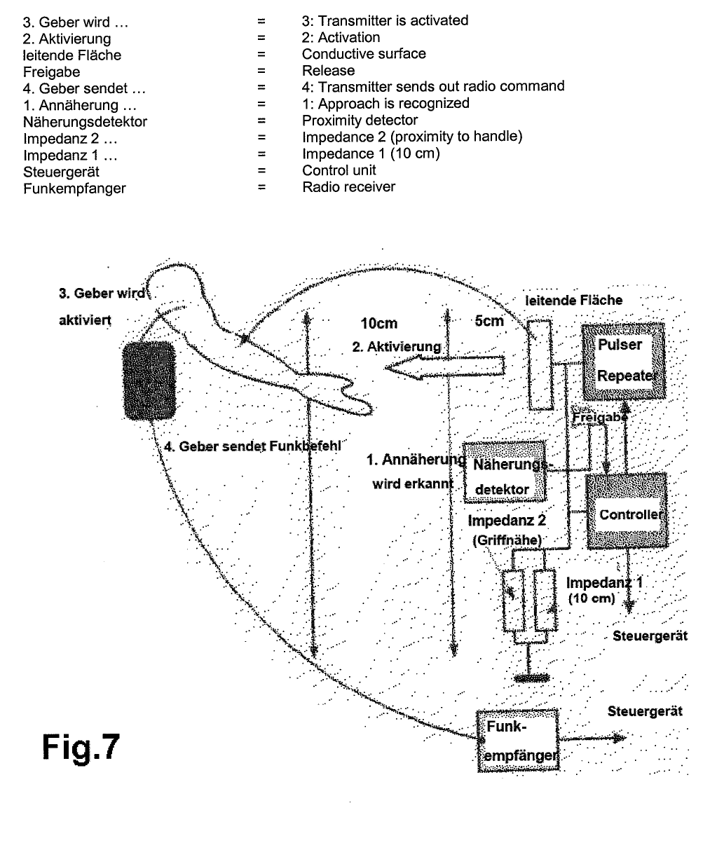

The operating principle of the inventive system is further illustrated in FIGS. 6 and 7. The user of a passenger car is approaching the car. Close to his body, he is carrying a traditional remote key, which has been supplemented by a body-detector unit (BDU).

Close to His Body Also Means:
in a wallet inserted into a garment (trousers, jacket, coat);
in a portable pouch (ladies' handbag, briefcase, backpack) that he is carrying with him.

If the user extends his hand toward the door handle, this action is detected via the sensor surfaces mounted there, beginning at a definable distance. For example, at a distance of 10 to 15 cm or less between the hand and handle, there begins a capacitive pulse/data transfer for activation/identification from the handle to the skin of the operator and thus to the remote key being worn or carried. The necessary authentication can therefore take place already while the hand is coming closer to the door handle. If the hand is introduced into the inner region of the handle within a time interval, so that the intent to open is clear, a coded signal is capacitively coupled to the skin of the user and/or the door is unlocked. The BDU recognizes capacitive signals, which then activate the radio module of the remote key via an electronic switch and prompt transmission of the radio signal, in the same way as if the corresponding button were operated by hand. Alternatively, it can be defined that the intent to open is clear only upon contact with the inside of the handle. The mechanical (or electrical) lock opens. If the door handle is not actuated, the lock closes after a suitable time interval. The locking operation takes place by actuation of the corresponding switch on the remote key. If the trigger no longer detects a.c. voltage signals, the radio key returns to a power-saving condition (sleep).

By the combination of the invention and traditional radio-based remote controllers, the known functionality thereof is preserved and thus operation over a distance of up to 20 m is possible.

1. Intent to enter a motor vehicle (or to pass through a stationary door equipped with the device)

Approach sensor in the door handle switches to external, approach of a hand toward the handle takes place, a.c. voltage trigger signal is output (modulated with data if applicable).

Case a) no response on the determining signal path (for example, by radio); consequence: unknown person in the immediate proximity (turn on light, emit warning sound, start image recording).

Case b) expected response on the determining signal path; consequence: preparatory measures that enable subsequent (intended) access, such as wake up control electronics from sleep condition, verify code, activate opening mechanism (do not yet unlock), change approach sensor query over to the inside of the handle.

Case b1) person retreats again; consequence: a timer expires, system remains locked, switch approach sensor to external, system goes into power-saving condition.

Case b2) sensor detects intent to open (approach inside the handle); consequence: unlocking takes place (unchecked, or by renewed triggering of the remote controller).

2. After Entry

Approach sensor switches (in order to assist door closing) to monitoring of closing edges in order to prevent pinching of body parts.

3. During actuation of automatic window lifters, monitor the closing edges to prevent pinching of body parts.

4. During Starting

Sensor is temporarily switched to starter knob and is queried once again during actuation thereof. Triggering is output via the skin of the driver (including seat control) as a capacitive alternating field. The remote controller in the radio key responds only if it is also located in the interior space (Faraday cage). Otherwise the key was lost during entry, and this can be indicated.

5. During Exiting

The door-opening switch signals that an exiting operation is taking place. After the door has closed, the sensor first checks whether the radio key (remote key) is still in the vehicle. For this purpose, a pulse is sent out via the handle. If a return signal is received, the driver has taken the key with him (has not forgotten it) and the door can be automatically locked. If the radio key has been left in the vehicle, the trigger signal cannot reach it (Faraday cage).

6. Standard Operation

The key may also be operated in the customary manner by pressing the buttons, since the invention merely bypasses these when the need requires.

1. A remote key access system with:
a radio key that can be activated by a switch device in order to output a radio signal, and
a signal-processing device constructed in the region of the radio key for activation of the switch device,
wherein the signal-processing device includes a receiving device for receiving a signal sequence that can be coupled via a modulated electrical alternating field into a user wearing or carrying the radio key, and wherein further the signal-processing device is configured in such a way that it undertakes activation of the switch device as a function of a data content that can be extracted from the received signal sequence.

2. A remote key access system with a circuit device to be worn or carried by the user and a circuit device provided on the vehicle side, wherein the two circuit devices are constructed in such a way that, upon penetration of limbs of a user into a zone relevant to a switching sequence control, there is generated a switching signal and, based on this switching signal, there is initiated the execution of an authorization routine for communication of a signal sequence used for verification of authorization to the circuit on the vehicle side.

3. A remote key access system according to claim 2, characterized in that a plurality of electrode devices is provided in the zone on the vehicle side, wherein at least one of these electrodes is provided in such a way that it permits detection of the presence of limbs of a living being in zones relevant to danger.

4. A system for executing signal-processing sequences by taking into consideration signals indicative of zone intrusions, wherein this system comprises means for generation of the signals indicative of zone intrusions on the basis of electric-field interaction effects, and circuitry is provided for automatic sequence initiation on the basis of the signals indicative of zone intrusions.

5. A system according to claim 4, characterized in that the system comprises an electrode device for generation of a modulated, quasi-static electric field as well as for obtaining the signal indicative of zone intrusions by way of interaction effects caused by that modulated quasi-static electric field.
